(19) United States
(12) Patent Application Publication
(10) Pub. No.: US 2025/0315499 A1
(43) Pub. Date: Oct. 9, 2025

(54) TECHNIQUES FOR MATRIX MULTIPLICATION IN HIGH-PERFORMANCE COMPUTING

(71) Applicant: IEX GROUP, INC., New York, NY (US)

(72) Inventors: Robert Park, New York, NY (US); Lieting Yu, Weehawken, NJ (US); Jesse Brent Yates, Atlanta, GA (US); Rahul D. Phadnavis, Fair Lawn, NJ (US); Kyle T. Kyrazis, Ann Arbor, MI (US); Andrew G. Rowles, New York, NY (US); Michael A. Frank, Mount Sinai, NY (US)

(21) Appl. No.: 18/627,260

(22) Filed: Apr. 4, 2024

(51) Int. Cl. G06F 17/16

(52) U.S. Cl. CPC G06F 17/16

(57) ABSTRACT

Techniques for improving the efficiency of matrix multiplication (matmul) operations are disclosed. According to one particular embodiment, an AI inference/training engine may be implemented with at least one controller and a plurality of workers. The controller(s), which may be merged with one or more of the workers, execute instructions for AI calculations which include matmul operations involving a first matrix; and the workers are collectively preloaded with the first matrix. When the controller encounters an instruction for a matmul operation, it may identify a second matrix to be multiplied with the first matrix and share the second matrix with the workers. Each worker then multiplies at least a portion of the second matrix with a corresponding preloaded portion of the first matrix to generate intermediate results and send them back to the controller(s) to generate a final product of the matmul operation.

### FIELD OF THE INVENTION

The inventions disclosed herein relate generally to apparatuses, methods, and systems for high-performance computing, including cloud computing and distributed computing. More particularly, the present inventions relate to techniques for improving the efficiency of matrix multiplication operations such as those in artificial intelligence training/inference and graphics rendering calculations.

### BACKGROUND OF THE INVENTION

Recent developments in artificial intelligence (AI) and machine learning (ML) technologies and related applications have led to skyrocketing demand for computational power. AI models can no longer be handled by single computers, and the training and inference calculations based on large models now require hundreds or thousands of computers or chips to execute. It has been recognized that matrix multiplication (matmul), as the cornerstone of many AI/ML algorithms, accounts for a large percentage of AI training and inference calculations. Matmul operations are also critical to non-AI applications, such as computer graphics and quantum physics.

The need for fast and intensive matrix multiplication (matmul) operations has driven the development of more powerful and more specialized computing hardware, such as graphics processing units (GPUs) and application specific integrated circuits (ASICs) with enhanced vector/matrix processing capabilities. But the improvement of hardware alone is not expected to keep up with the increasing demand for matmul performance. In addition, high-performance hardware devices such as Nvidia's GPUs have become more scarce and more expensive.

Rather than relying solely on the availability and performance of GPUs or other specialized hardware, there is a need to improve the use of existing resources and infrastructures in order to meet the computational demand of AI/ML, online gaming, and other matmul-intensive applications.

### SUMMARY OF THE INVENTION

To overcome the above-mentioned and other problems and shortcomings in the prior art, the present application discloses a number of techniques for improving the utilization of computing resources.

According to some embodiments of the present inventions, a method for improving AI calculations may comprise the step of configuring at least one controller to execute instructions for AI calculations, where the AI calculations include one or more matrix-multiplication (matmul) operations involving a first matrix. The method may also comprise the step of preloading a plurality of workers collectively with the first matrix such that each worker is preloaded with at least one portion of the first matrix, the plurality of workers being communicatively coupled to the at least one controller. The method may further comprise the step of causing the at least one controller to perform the following steps upon encountering an instruction, among the instructions for the AI calculations, for one of the one or more matmul operations: (1) identifying a second matrix to be multiplied with the first matrix as part of the one of the one or more matmul operations; (2) making the second matrix available to the plurality of workers, thereby enabling each worker to multiply at least one portion of the second matrix with a corresponding preloaded portion of the first matrix to generate one or more of a plurality of intermediate results; (3) receiving the plurality of intermediate results from the plurality of workers; and (4) generating a final product of the second matrix and the first matrix based on the plurality of intermediate results.

According to particular embodiments, the second matrix may be made available to the plurality of workers respectively via an event stream-based multicast or broadcast procedure; and the at least one controller may receive the plurality of intermediate results from the plurality of workers respectively via peer-to-peer or reliable multicast connections such as the event stream-based procedure.

According to some other embodiments of the present inventions, a system for improving AI calculations may comprise at least one controller configured to execute instructions for AI calculations, where the AI calculations include one or more matrix-multiplication (matmul) operations involving a first matrix. The system may also comprise a plurality of workers communicatively coupled to the at least one controller, the plurality of workers being collectively preloaded with the first matrix such that each worker is preloaded with at least one portion of the first matrix. And the at least one controller may be configured to perform the following steps upon encountering an instruction, among the instructions for the AI calculations, for one of the one or more matmul operations: (1) identifying a second matrix to be multiplied with the first matrix as part of the one of the one or more matmul operations; (2) making the second matrix available to the plurality of workers, thereby enabling each worker to multiply at least one portion of the second matrix with a corresponding preloaded portion of the first matrix to generate one of a plurality of intermediate results; (3) receiving the plurality of intermediate results from the plurality of workers; and (4) generating a final product of the second matrix and the first matrix based on the plurality of intermediate results.

In certain preferred embodiments, the above-described at least one controller may be combined with or merged into, or implemented in a same virtual or physical machine as, one or more of the plurality of workers. And the workers may communicate with one another based on an event stream-based multicast or broadcast procedure.

The plurality of workers may comprise a plurality of virtual machines (VMs) which are based on one or more central processing units (CPUs), tensor processing units (TPUs), or field programmable gate arrays (FPGAs) and further configured to emulate one or more graphics processing units (GPUs). The emulation may be based on one or more factors selected from a group consisting of: a target performance of the one or more GPUs to be emulated; computation capabilities of the one or more CPUs; vector processing capabilities of at least one co-processor or processor core of the one or more CPUs; communication bandwidth available to the one or more CPUs; power consumption of the one or more CPUs; heat generation by the one or more CPUs; and a computation workload required for the one or more matmul operations.

The present inventions will now be described in more detail with reference to exemplary embodiments thereof as shown in the accompanying drawings. While the present inventions are described below with reference to exemplary embodiments, it should be understood that the present inventions are not limited thereto. Those of ordinary skill in the art having access to the teachings herein will recognize additional implementations, modifications, and embodiments, as well as other fields of use, which are within the scope of the present inventions as described herein, and with respect to which the present inventions may be of significant utility.

### BRIEF DESCRIPTION OF THE DRAWINGS

In order to facilitate a fuller understanding of the present inventions, reference is now made to the accompanying drawings, in which like elements are referenced with like numerals. These drawings should not be construed as limiting the present inventions, but are intended to be exemplary only.

FIGS. 1A-1B provide an illustrative example showing a technique for improving matmul operations in accordance with embodiments of the present inventions.

FIGS. 2A-2B provide another illustrative example showing an alternative technique for improving matmul operations in accordance with embodiments of the present inventions.

FIG. 3 shows a flow diagram illustrating an exemplary method for improving AI inference calculations in accordance with embodiments of the present inventions.

FIG. 4 provides a logic flow illustrating aspects of the techniques for improving AI training/inference calculations in accordance with embodiments of the present inventions.

FIG. 5 provides another logic flow illustrating aspects of the techniques for improving AI training/inference calculations in accordance with alternative embodiments of the present inventions.

### DETAILED DESCRIPTION OF THE INVENTION

Embodiments of the present inventions aim to improve the utilization of computational resources for AI/ML calculations and other applications, such as in a distributed or cloud computing environment. For ease of explanation and not by way of limitation, the following description will focus on examples of AI inference calculations based on oversimplified models and prompts. For example, one of ordinary skill in the art will appreciate that the same or similar techniques as disclosed herein may be adapted for and applied to other AI calculations, such as the training of AI models, where intensive matmul operations are similarly required and need to be optimized.

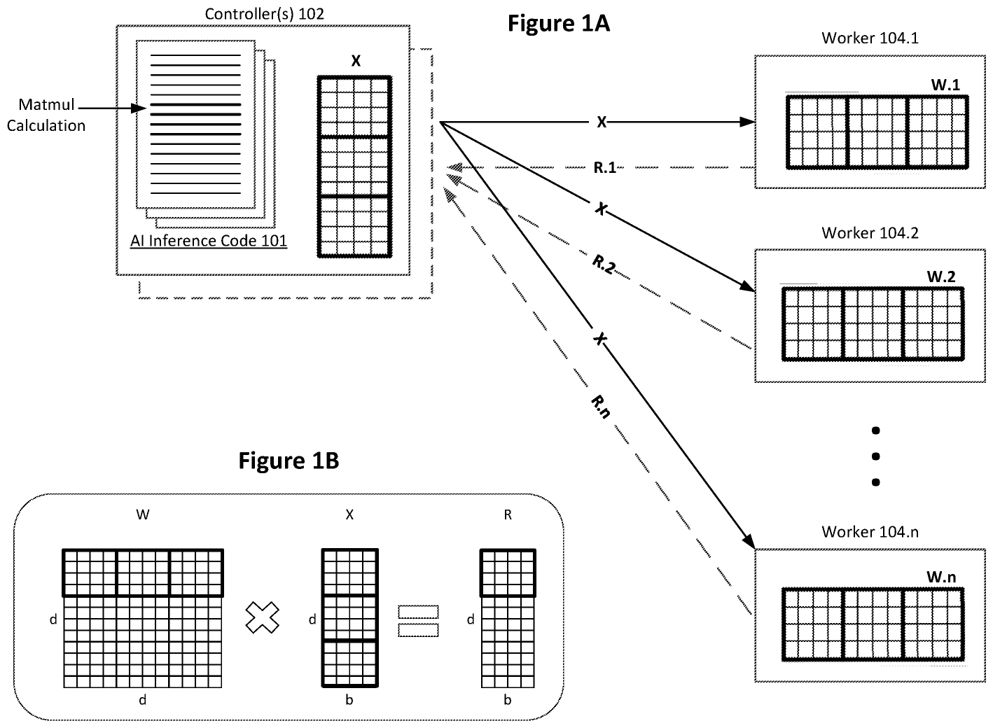

Referring to FIGS. 1A-1B, there is shown an illustrative example of a technique for improving matmul operations in accordance with embodiments of the present inventions.

In this example, at least one controller 102 and a number of workers (104.1, 104.2, . . . 104.n) may be set up in a computing environment where the controller(s) 102 and the workers are communicatively coupled, preferably over high-speed connections.

A controller 102 may be part of, or implemented on, a virtual machine (VM) or physical devices such as central processing units (CPUs), processor cores, tensor processing units (TPUs), field programmable gate arrays (FPGAs), or GPUs. Similarly, each worker may be implemented on a VM or physical devices. For example, according to one embodiment of the present inventions, each worker may be a VM with fifty processor cores, and a group of 20-40 such workers could then aggregate the computing power of 1,000-2,000 processor cores.

The controller(s) 102 may be configured to execute AI inference code 101 where the inference calculations involve a large number of matrix multiplication (matmul) operations. As a simplified example, such matmul operations may involve the multiplication of a first matrix W representing the AI model parameters (e.g., weights) and a second matrix X representing the inference input values. More specifically, Matrix W may include or represent one or more of the weight matrices, W_{Q}, W_{K}, and W_{V}, which are used against the Query, Key, and Value vectors created from the inference input. FIG. 1B shows conceptually the multiplication of the two matrices, W and X, to produce an output, Matrix R.

According to embodiments of the present inventions, the workers (104.1, 104.2, . . . 104.n) may be collectively preloaded with the AI model, Matrix W, so that each worker is loaded with at least a portion of the model before the controller(s) 102 start to execute the AI inference code. Matrix W may be broken into tiles that are then allocated to the workers based on a tiled matmul scheme. According to one embodiment, each worker is preferably allocated, and owns, a full row of Matrix W (or a full column of Matrix W if it is loaded in a transposed format).

During execution of the AI inference code 101, the controller(s) 102 may be primarily responsible for performing non-matmul calculations. When the controller(s) 102 encounters an instruction for a matmul operation, the controller may first identify the input matrix, Matrix X, to be multiplied with the AI model, Matrix W. The controller(s) 102 may optionally split Matrix X into a number of tiles before sharing them with the workers, all in accordance with how Matrix W has been tiled and allocated to the workers. According to a preferred embodiment of the present inventions, Matrix X in its entirety may be provided to each of the workers via a reliable multicast/broadcast or fanout scheme involving at least one sequencer and repeaters in connection with an event stream, as will be described in more detail below. The controller(s) 102 may further initiate threads to manage responses from the workers.

Once Matrix X or its tiles have been received by the relevant workers, each of those workers may proceed to compute tile-based matmul to generate an intermediate result from that worker's allocated portions (or tiles) of Matrix W and Matrix X. The intermediate result may also be in the form of a small matrix (tile). The workers may send the intermediate results (R.1, R.2, . . . . R.n) back to the controller(s) 102 via a reliable protocol such as peer-to-peer (P2P) connections or event stream-based multicast/broadcast.

Upon receiving the intermediate results (R.1, R.2, . . . . R.n) from all relevant workers, the controller(s) 102 may generate a final product of Matrix W and Matrix X based on the intermediate results in accordance with the tile-based matmul. According to a preferred embodiment, the controller(s) 102 may be able to simply concatenate the intermediate results if they resulted from multiplying full-row tiles of Matrix W (as preloaded onto the workers) with Matrix X, as illustrated in FIG. 1B. If the workers are not preloaded with full-row tiles, or if Matrix X is split into tiles and not shared in its entirety with each worker, then the workers may need to perform partial multiplications and the controller(s) 102 may have to perform more steps (e.g., additions or partial reduce) than mere concatenation of the intermediate results before the final product, Matrix R, could be generated.

When the final result of the current matmul operation has been produced through the above-described process, the controller(s) 102 may continue to the next instruction in the AI inference code 101. And when another matmul operation is encountered in the code, the above process may be repeated, for example, with a different Matrix X as inference input (the second matrix).

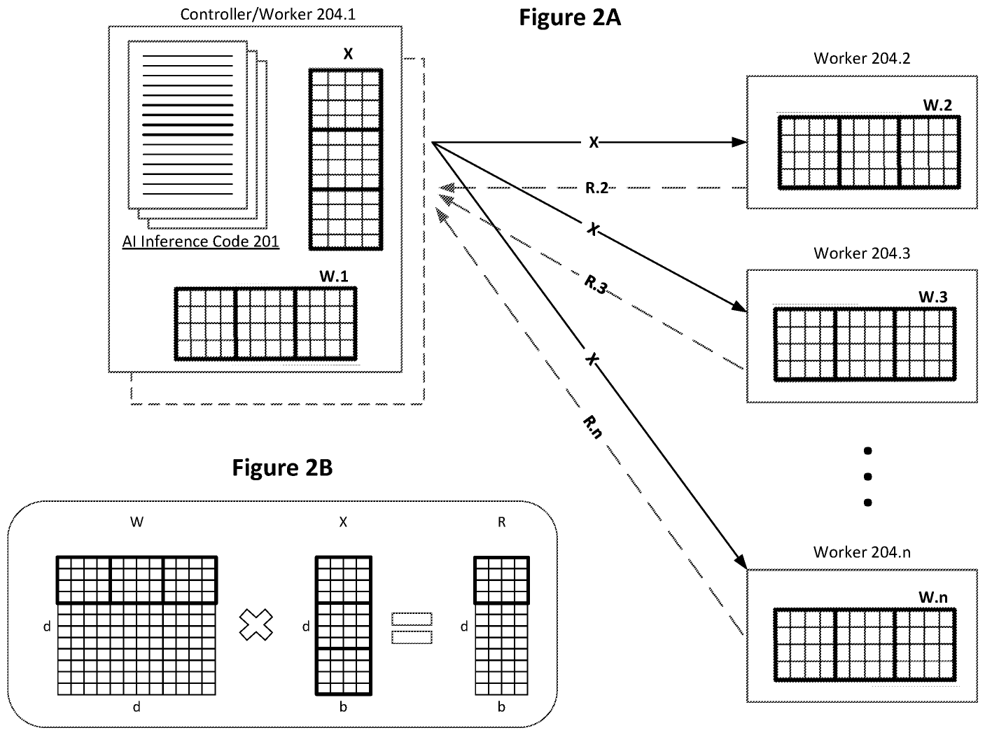

FIGS. 2A-2B provide another illustrative example showing an alternative technique for improving matmul operations in accordance with embodiments of the present inventions. This example is substantially the same as the one illustrated in FIGS. 1A-1B except that the controller is now merged with one or more of the workers. For example, the virtual or physical machine of worker 204.1 also runs the controller functions or a number of the workers may collectively share the controller functions. This configuration is advantageous because it cuts down the communication delay between a standalone controller and the worker 204.1, for example.

The rest of the example shown in FIGS. 2A-2B is similar to what is illustrated in FIGS. 1A-1B: (1) the workers are preloaded collectively with Matrix W (the AI model), preferably with full-row tiles (or full-column tiles if Matrix W is transposed); (2) during execution of AI inference code 201, when a matmul operation is encountered, the controller/worker 204.1 will identify Matrix X (inference input/prompt) and share it or its tiles with the workers (204.2, 204.3, . . . 204.n) via a reliable, event stream-based fanout multicast/broadcast; (3) the workers will then perform tile-based matmul to generate intermediate results and share them with the controller/worker 204.1 via P2P connections or share the intermediate results with the other workers via event stream-based multicast/broadcast; (4) the controller/worker 204.1 (or another chosen worker) will collect the intermediate results and accordingly generate the final result of the matmul operation; and (5) the execution of the AI inference code 201 continues until another matmul operation is encountered and the process in Steps (2)-(4) may be repeated.

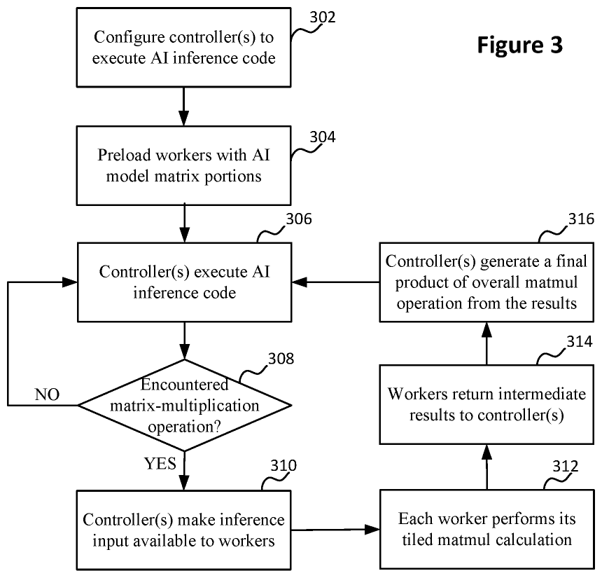

FIG. 3 shows a flow diagram illustrating an exemplary method for improving AI inference calculations in accordance with embodiments of the present inventions.

First, in Step 302, one or more controllers may be configured to execute instructions for AI inference calculations or to run computer programs containing such instructions. The controller(s) may each be implemented with a VM or a thread/process running on the VM or physical device(s). The AI inference calculations are expected to include multiple matmul operations, typically involving a first matrix or set of matrices representing weight parameters of an AI model and a second matrix representing varying inference inputs or prompts.

Next, in Step 304, a number of workers may be preloaded with the first matrix or set of matrices. As the AI inference code is expected to keep reusing the same AI model, it may be efficient to load portions of the model, in the form of matrix tiles, onto the workers, so that the model as a whole remains available to the workers collectively through the execution of the AI inference code. The preloading of the workers may involve storing the AI matrix portions (or tiles) in memory or registers for fast, repeated access by execution units. According to some embodiments, it may be beneficial to take advantage of compiler intrinsics functions to persistently load into a register device at least part of a worker's preloaded AI matrix portion, so that the persistently loaded data can be reused for multiple multiplications without wastefully reloading the data. It may be desirable to adjust the sequence of tiled matmul operations based on the register content in order to reduce or avoid reloading the register with the same content. Such optimized use of registers may significantly improve the efficiency and speed of the overall matmul operations.

The first matrix (AI model) may be split and then allocated to the workers in accordance with a desired scheme of tile-based matmul between the first and second matrices. According to a preferred embodiment, it may be beneficial to split the AI model into full-row tiles and to allocate ownership of an entire row of the first matrix to a single worker. Such full-row allocations—such that a row of tiles is not split among multiple workers—may reduce the amount of additional computations required on the intermediate results generated by the workers.

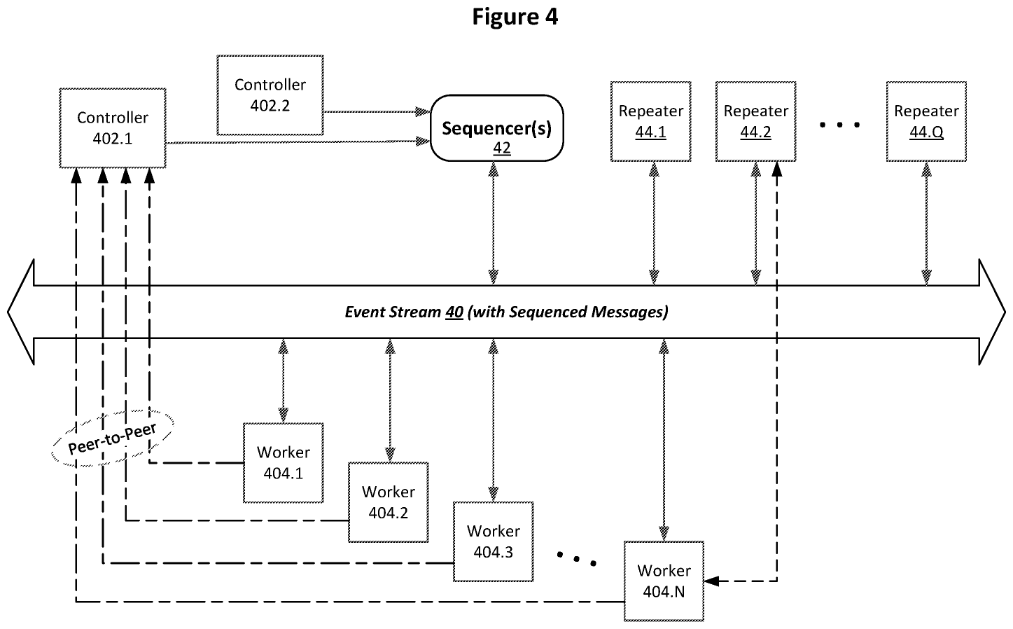

In Step 306, the controller(s) may start and continue executing the AI inference code. As the controller(s) tick through the instructions line by line, it may be determined, in Step 308, whether a matmul operation is encountered. If not, the process may loop back to Step 306 for the controller(s) to continue to the next instruction in the AI inference code. Otherwise, if a matmul operation is encountered, the controller(s) may, in Step 310, make the inference input (the second matrix) available to the respective workers, or the second matrix could be optionally split into tiles in accordance with a desired tiling scheme. The sharing of the second matrix or its tiles with the workers may be accomplished with a reliable multicast on an event stream (as described in more detail below in connection with FIG. 4).

As a result, the second matrix or its tiles are allocated to the workers (and preferably placed into their contiguous memory space) to enable each worker to multiply the tile(s) from the second matrix with its preloaded, corresponding tile(s) or rows/columns of the first matrix. In Step 312, such tiled matmul calculations may be performed substantially in parallel by the various workers.

Upon completing their own tiled matmul calculations, the workers may then return the intermediate results of those calculations to the controller(s) in Step 314. The results may be sent from the workers to the controller(s) either via P2P connections or through a multicast on an event stream (as described in more detail below).

In Step 316, the controller(s), as a manager and coordinator of the workers, may generate a final product of the overall matmul between the first and second matrices based on the intermediate results received from the workers. The amount and complexity of the operations required for the controller(s) to generate the final product may vary based on the tiling scheme. If the workers have been preloaded with, and perform matmul operations on, full-row tiles of the first matrix, then the controller(s) may only need to concatenate the intermediate results; otherwise, the controller(s) may have to perform a series of additions among the intermediate results before the concatenation.

Once the final product of the current matmul operation has been generated, the exemplary process may again loop back to Step 306 for the controller(s) to move on to the next instruction in the AI inference code.

As one of ordinary skill in the art may appreciate, multiple system architectures could be used to implement the techniques disclosed herein. For example, one type of architectures may employ at least one standalone controller to coordinate the matmul operations of multiple workers, where the at least one controller sends the AI inference input (second matrix) to the workers via event stream-based multicast/broadcast while the workers return intermediate results to the at least one controller via peer-to-peer connections or event stream-based multicast/broadcast. Another type of architectures may include no standalone controller(s), and multiple workers share the non-matmul functions that would otherwise be performed by controller(s), where the workers all communicate with one another via event stream-based multicast/broadcast.

FIG. 4 provides a logic flow illustrating aspects of the techniques for improving AI training/inference calculations in accordance with embodiments of the present inventions.

As mentioned above, the sharing of an input matrix (e.g., Matrix X) with workers is preferably done through a reliable multicast scheme involving a sequencer and repeaters. FIG. 4 illustrates one example of the multicast scheme where controllers (402.1, 402.2) and workers (404.1, 404.2, 404.3, . . . 404.N) are configured in a distributed computing environment to implement the AI inference calculations as disclosed herein.

In the same computing environment, one or more sequencers 42 and related repeaters (44.1, 44.2, . . . 44.Q) may be implemented, in order to make the controller-to-worker data transmissions more dependable, by generating and maintaining an event stream 40 that carries sequenced messages. The techniques for creating and using such an event stream were disclosed in U.S. Pat. Nos. 10,678,694 and 10,901,905, both titled “System and Method for Creating Time-Accurate Event Streams,” which are incorporate by reference herein in their entireties. As previously disclosed, the sequencer 42 may comprise a number of writers and readers that collectively ingest incoming messages from applications running in the computing environment, apply timestamps to the messages, and sequence them into a time-accurate event stream that could be trusted by the applications.

Instead of sending data directly to the workers, the controller(s) (402.1, 402.2) may send messages carrying an AI inference input (e.g., Matrix X) to the sequencer 42. Those messages will be timestamped and ordered with sequence numbers before being published on the event stream 40. Apart from those sequenced messages carrying the inference input, the sequencer 42 may also send out “heartbeat” messages with their own sequence numbers onto the event stream, for example, at a frequency of four times per second.

On the other hand, each worker may “listen” for messages from the controller(s) (402.1, 402.2) and obtain from the event stream the ones intended for it as the recipient. With the sequence numbers assigned to the messages on the event stream, the workers are able to identify gaps in the sequenced messages and may request missing message(s) initially from one of the repeaters (44.1, 44.2, . . . 44.Q) or ultimately from the sequencer 42 if the missing message(s) are unavailable from the repeaters. Here, the heartbeat messages with their own sequence numbers could also help alert a worker to a gap in the sequenced messages carrying the AI inference input.

According to some embodiments of the present inventions, the controller(s) and sequencer(s) may be implemented in a number of ways. For example, they may be separate processes on separate hosts, separate processes on the same host, or logically merged into a single process on a single host. In the alternative, either or both the controller(s) and sequencer(s) may be implemented on a hardware device such as a field programmable gate array (FPGA) module.

As also mentioned above, the workers may preferably send back the intermediate results of their tile-based matmul calculations back to the controller(s) via reliable P2P connections. Exemplary P2P connections are illustrated in FIG. 4 between the controller 402.1 and the workers (404.1, 404.2, 404.3, . . . 404.N). Such P2P communications may be on ad hoc connections but are more preferably on permanent or dedicated connections with a high bandwidth such as 10 Gbps or more. With the P2P communications, the messages or packets from the workers to the controller(s) need not be sequenced by the sequencer(s) and the transmissions might be faster than the event stream-based multicast method. According to an alternative embodiment, the flow of the intermediate results of the tile-based matmul calculations may also go through the event stream-based multicast scheme as described above. In this case, the messages carrying the intermediate results will be sequenced and broadcast on the event stream, which method may be more suitable when several controllers are being coordinated in the AI inference calculations or when a failed worker is replaced with a new worker that has to recreate the failed worker's state and continue processing.

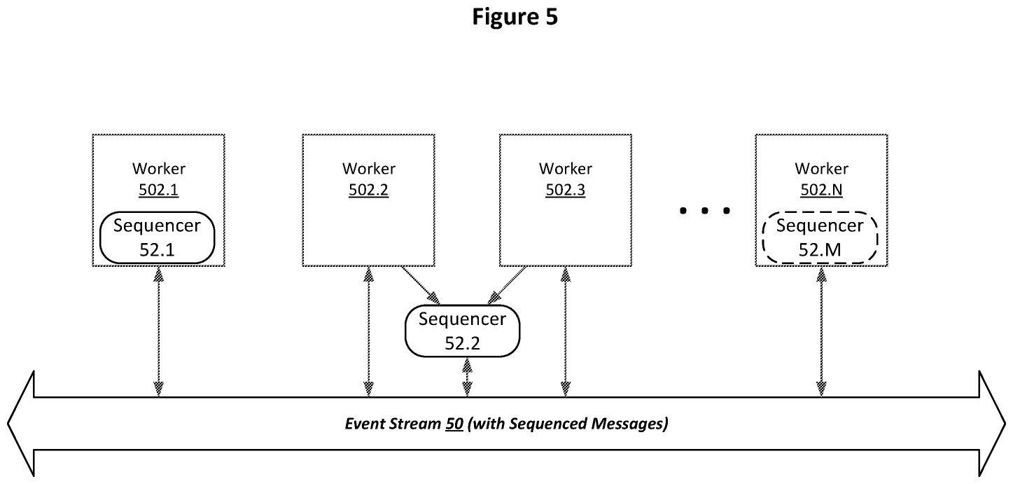

FIG. 5 provides another logic flow illustrating aspects of the techniques for improving AI training/inference calculations in accordance with alternative embodiments of the present inventions. In these alternative embodiments, the above-described controller (non-matmul) functions may be spread to one or more workers (502.1, 502.2, 502.3, . . . 502.N) and these workers may communicate with one another all through an event stream-based multicast/broadcast procedure. In particular, each worker or worker/controller may have an embedded sequencer (e.g., Worker 502.1 with embedded Sequencer 52.1, Worker 502.N with embedded Sequencer 52.M), or two or more workers or worker/controllers may share a sequencer (e.g., Worker 502.1 and Worker 502.3 sharing Sequencer 52.2).

To execute AI inference code, the workers (502.1, 502.2, 502.3, . . . 502.N) will closely coordinate with one another to preload portions of the AI model matrix (first matrix) into memory space, receive and share an inference input matrix (second matrix), return intermediate results of their respective matmul calculations, and generate a final product of the first and second matrices based on the intermediate results, preferably all through communications via the sequencers (52.1, 52.2, . . . 52.M) and the event stream 50. While one worker or worker/controller may serve as a central controller to ultimately complete the generation of the final product, most of the other operations required for the AI inference calculations may be distributed among and managed collectively by the multiple workers or worker/controllers.

According to embodiments of the present inventions, the workers (and/or controllers), such as those illustrated in FIG. 4 or FIG. 5, may be implemented on CPU-based VMs that are selected and configured to emulate one or more GPUs. With the scarcity of GPU resources, it may be desirable to utilize and coordinate available CPUs and their co-processors to provide computational performance comparable to GPUs and at comparable or even lower costs. The selection and configuration of the VMs for this purpose may be based on factors such as: (1) a target performance of the GPU(s) to be emulated; (2) computation capabilities of the CPUs; (3) vector processing capabilities of at least one co-processor or processor core of the CPUs; (4) communication bandwidth available to the CPUs; (5) power consumption of the CPUs; (6) heat generation by the CPUs; and (7) a computation workload required for the matmul operations to be completed. According to some embodiments, the CPUs preferably include co-processors or processor cores adapted for vector processing, such as Advanced Vector Extensions (AVX) or Advanced Matrix Extensions (AMX) co-processors.

Furthermore, in the various embodiments of the present inventions as described above, it may be advantageous to configure controller(s), workers, worker/controllers, or related processes or functions in order to enable data prefetching for some or all of the workers. That is, during the above-described matmul calculations that have been substantially parallelized among the workers or worker/controllers, one worker or worker/controller may complete, or be about to complete, its own matmul operation for a current calculation that the other workers are still working on. In that case, rather than allowing this one worker or worker/controller to idle and wait for the other workers, the process may look ahead to the next matmul operation, as part of a series of AI inference/training instructions, that this worker or worker/controller will need to perform and cause the related data to be prefetched and loaded to the fast-access memory space (e.g., L1, L2, or L3 cache registers). This may allow one worker to proceed further down the parallel matmul operations ahead of its peers, but this worker could keep the other workers, worker/controllers, or controller(s) informed of its own state or progress via the event stream-based multicast/broadcast procedure.

In order to address various issues and advance the art, the entirety of this application (e.g., the Cover Page, Title, Headings, Field, Background, Summary, Brief Description of the Drawings, Detailed Description, Claims, Abstract, and/or Figures) shows by way of illustration various example embodiments in which the claimed innovations may be practiced. The advantages and features of the present inventions are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, processors, services, servers, and/or the like that may execute asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations-in-part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims.

1. A method for improving artificial intelligence (AI) calculations, the method comprising:
configuring at least one controller to execute instructions for AI calculations, where the AI calculations include one or more matrix-multiplication (matmul) operations involving a first matrix;
preloading a plurality of workers collectively with the first matrix such that each worker is preloaded with at least one portion of the first matrix, the plurality of workers being communicatively coupled to the at least one controller; and
causing the at least one controller to perform the following steps upon encountering an instruction, among the instructions for the AI calculations, for one of the one or more matmul operations:
1) identifying a second matrix to be multiplied with the first matrix as part of the one of the one or more matmul operations,
2) making the second matrix available to the plurality of workers, thereby enabling each worker to multiply at least one portion of the second matrix with a corresponding preloaded portion of the first matrix to generate one or more of a plurality of intermediate results,
3) receiving the plurality of intermediate results from the plurality of workers, and
4) generating a final product of the second matrix and the first matrix based on the plurality of intermediate results.

2. The method of claim 1, wherein the at least one portion of the first matrix comprises full-row or full-column tiles, and wherein the step 4) of generating the final product comprises concatenating the plurality of intermediate results.

3. The method of claim 1, wherein the at least one portion of the first matrix comprise partial-row or partial-column tiles, and wherein the step 4) of generating the final product comprises at least one partial reduce operation based on the plurality of intermediate results.

4. The method of claim 1, wherein the second matrix is made available to the plurality of workers respectively via an event stream-based multicast or broadcast procedure.

5. The method of claim 4, wherein the event stream-based multicast or broadcast procedure comprises:
sequencing a series of messages that collectively carry the second matrix;
inserting the sequenced series of messages into an event stream along with heartbeat messages, each of the sequenced series of messages and heartbeat messages having a unique sequence number; and
causing the plurality of workers to determine, based at least in part on the sequenced series of messages in the event stream, whether they have received allocated portions of the sequenced series of messages and to request missing message(s) as needed.

6. The method of claim 1, wherein the at least one controller receives the plurality of intermediate results from the plurality of workers respectively via peer-to-peer or reliable multicast connections.

7. The method of claim 1, wherein the at least one controller receives the plurality of intermediate results from the plurality of workers respectively via an event stream-based multicast or broadcast procedure.

8. The method of claim 1, wherein the first matrix represents an AI model.

9. The method of claim 8, wherein the second matrix represents a prompt to the AI model.

10. The method of claim 1, further comprising:
configuring the at least one controller to operate in a same virtual or physical machine as one of the plurality of workers.

11. The method of claim 1, further comprising:
spreading a part of the at least one controller's workload to one or more of the plurality of workers.

12. The method of claim 1, further comprising:
causing at least part of a first matrix portion preloaded onto a worker or a second matrix portion to be persistently loaded into a register device accessible by the worker for multiple multiplications without wastefully reloading the at least part of the first matrix portion or the second matrix portion.

13. The method of claim 1, further comprising:
causing data related to a next instruction among the instructions for the AI calculations to be prefetched into a fast-access memory space for one of the plurality of workers that has completed or is about to complete a current matmul operation.

14. A controller adapted for improving artificial intelligence (AI) calculations, the controller being programmed to:
execute instructions for AI calculations, where the AI calculations include one or more matrix-multiplication (matmul) operations involving a first matrix;
cause a plurality of workers to be preloaded collectively with the first matrix such that each worker is preloaded with at least one portion of the first matrix, the plurality of workers being communicatively coupled to the controller; and
perform the following steps upon encountering an instruction, among the instructions for the AI calculations, for one of the one or more matmul operations:
1) identifying a second matrix to be multiplied with the first matrix as part of the one of the one or more matmul operations,
2) making the second matrix available to the plurality of workers, thereby enabling each worker to multiply at least one portion of the second matrix with a corresponding preloaded portion of the first matrix to generate one of a plurality of intermediate results,
3) receiving the plurality of intermediate results from the plurality of workers, and
4) generating a final product of the second matrix and the first matrix based on the plurality of intermediate results.

15. The controller of claim 14, being combined with or merged into, or implemented in a same virtual or physical machine as, one or more of the plurality of workers.

16. A system for improving artificial intelligence (AI) calculations, the system comprising:
at least one controller configured to execute instructions for AI calculations, where the AI calculations include one or more matrix-multiplication (matmul) operations involving a first matrix; and
a plurality of workers communicatively coupled to the at least one controller, the plurality of workers being collectively preloaded with the first matrix such that each worker is preloaded with at least one portion of the first matrix;
wherein the at least one controller is configured to perform the following steps upon encountering an instruction, among the instructions for the AI calculations, for one of the one or more matmul operations:
1) identifying a second matrix to be multiplied with the first matrix as part of the one of the one or more matmul operations,
2) making the second matrix available to the plurality of workers, thereby enabling each worker to multiply at least one portion of the second matrix with a corresponding preloaded portion of the first matrix to generate one of a plurality of intermediate results,
3) receiving the plurality of intermediate results from the plurality of workers, and
4) generating a final product of the second matrix and the first matrix based on the plurality of intermediate results.

17. The system of claim 16, wherein the at least one controller is combined with or merged into, or implemented in a same virtual or physical machine as, one or more of the plurality of workers.

18. The system of claim 16, wherein the plurality of workers comprise a plurality of virtual machines (VMs) which are based on one or more central processing units (CPUs), tensor processing units (TPUs), or field programmable gate arrays (FPGAs) and further configured to emulate one or more graphics processing units (GPUs).

19. The system of claim 18, wherein the plurality of VMs are configured based on one or more factors selected from a group consisting of:
a target performance of the one or more GPUs to be emulated;
computation capabilities of the one or more CPUs;
vector processing capabilities of at least one co-processor or processor core of the one or more CPUs;
communication bandwidth available to the one or more CPUs;
power consumption of the one or more CPUs;
heat generation by the one or more CPUs; and
a computation workload required for the one or more matmul operations.

20. The system of claim 16, wherein at least one of the plurality of workers comprises, or is based on, a central processing unit (CPU), a tensor processing unit (TPU), a field programmable gate array (FPGA), a graphics processing unit (GPU), or a combination thereof.

21. The system of claim 20, wherein the CPU, TPU, FPGA, or GPU comprises at least one co-processor or processor core adapted for vector or matrix processing.

22. The system of claim 21, wherein the at least one co-processor or processor core adapted for vector or matrix processing comprises at least one Advanced Vector Extensions (AVX) or Advanced Matrix Extensions (AMX) co-processor or one or more hardware acceleration co-processors.

23. The system of claim 16, wherein the plurality of workers are based on central processing units (CPUs).

24. A non-transitory machine-readable storage medium having stored thereon a computer program with instructions that, when executed by at least one processor, performs artificial intelligence (AI) calculations, the storage medium comprising instructions for:
configuring at least one controller to execute instructions for AI calculations, where the AI calculations include one or more matrix-multiplication (matmul) operations involving a first matrix;
preloading a plurality of workers collectively with the first matrix such that each worker is preloaded with at least one portion of the first matrix, the plurality of workers being communicatively coupled to the at least one controller; and
causing the at least one controller to perform the following steps upon encountering an instruction, among the instructions for the AI calculations, for one of the one or more matmul operations:
1) identifying a second matrix to be multiplied with the first matrix as part of the one of the one or more matmul operations,
2) making the second matrix available to the plurality of workers, thereby enabling each worker to multiply at least one portion of the second matrix with a corresponding preloaded portion of the first matrix to generate one of a plurality of intermediate results,
3) receiving the plurality of intermediate results from the plurality of workers, and
4) generating a final product of the second matrix and the first matrix based on the plurality of intermediate results.

25. A method for improving artificial intelligence (AI) calculations, the method comprising:
configuring a plurality of workers to coordinate in execution of instructions for AI calculations, where the AI calculations include one or more matrix-multiplication (matmul) operations involving a first matrix, and where the plurality of workers are in communications with one another via an event stream-based multicast or broadcast procedure;
preloading the plurality of workers collectively with the first matrix such that each worker is preloaded with at least one portion of the first matrix; and
causing the plurality of workers to perform the following steps upon encountering an instruction, among the instructions for the AI calculations, for one of the one or more matmul operations:
1) identifying a second matrix to be multiplied with the first matrix as part of the one of the one or more matmul operations,
2) making the second matrix available to the plurality of workers, thereby enabling each worker to multiply at least one portion of the second matrix with a corresponding preloaded portion of the first matrix to generate one or more of a plurality of intermediate results, and
3) generating a final product of the second matrix and the first matrix based on the plurality of intermediate results.

26. The method of claim 25, wherein the event stream-based multicast or broadcast procedure comprises:
sequencing a series of messages that collectively carry the second matrix;
inserting the sequenced series of messages into an event stream along with heartbeat messages, each of the sequenced series of messages and heartbeat messages having a unique sequence number; and
causing the plurality of workers to determine, based at least in part on the sequenced series of messages in the event stream, whether they have received allocated portions of the sequenced series of messages and to request missing message(s) as needed.
